(19) United States
(12) Patent Application Publication
(10) Pub. No.: US 2015/0089499 A1
(43) Pub. Date: Mar. 26, 2015

(54) TOPOLOGY MANAGEMENT METHOD AND SYSTEM OF VIRTUAL MACHINES

(71) Applicant: DELTA ELECTRONICS, INC., Taoyuan County (TW)

(72) Inventors: Pa HSUAN, Taoyuan County (TW); Wen-Min HUANG, Taoyuan County (TW); Chih-Yang LIU, Taoyuan County (TW)

(73) Assignee: DELTA ELECTRONICS, INC., Taoyuan County (TW)

(21) Appl. No.: 14/086,082

(22) Filed: Nov. 21, 2013

(30) Foreign Application Priority Data
Sep. 25, 2013 (TW) 102134631

(51) Int. Cl. G06F 9/455

(52) U.S. Cl. CPC G06F 9/45533
USPC 718/1

(57) ABSTRACT

A system for managing topology of virtual machines (VMs) includes a base-information database, an information register processing unit, and a topology information database. The base-information database records internal information of all VMs of a cloud system. The information register processing unit monitors the base-information database for updating the internal information of the VMs to the topology information database. The topology information database mainly records a mapping between an alias name and a hostname of each VM, and also records a mapping between the hostname and IP address of each VM. The alias name of each VM is defined in accordance with the task assigned to the VM in the cloud system.

### BACKGROUND OF THE INVENTION

1. Field of the Invention

The present invention relates to a management method and system of virtual machines (VMs), especially to a topology management method and system for automatically managing and updating topology of virtual machines (VMs) in virtual environment of cloud system.

2. Description of Related Art

As the computer hardware ability becomes sufficiently powerful, virtual machines (VMs) architecture with several virtual computers running by one physical computer (namely, the physical machine) is proposed. Those virtual machines share the same single physical computer such that the manager only needs to maintain the single physical computer while the virtual machines can provide different services for user to save labor force, space and cost.

FIG. 1 shows a schematic diagram of a related art management scheme for virtual machines. In cloud end center there are a plurality of physical machines 1 and at least one base-information database 2 operatively connected to the plurality of physical machines 1. Generally, the physical machine 1 writes the host name and IP address assigned to one virtual machine 3 into the base-information database 2 to pre-indicate the virtual machine 3. Afterward, the physical machine 1 installs the virtual machine 3 according to the hostname and IP address assigned to the virtual machine 3.

The plurality of virtual machines 3 provided by the single physical machine 1 share the hardware resource of the single physical machine 1. The hardware resource of the single physical machine 1 tends to be overloaded and the cloud end system becomes instable when many users access the plurality of virtual machines 3 simultaneously. Therefore, the physical machines 1 need to perform migration for the plurality of virtual machines 3 running thereon to balance the loading of the physical machines 1.

The manager can operate an inquiry terminal 4 to inquiry a specific virtual machine 3, where the inquiry terminal 4 is operatively connected to the base-information database 2 for inquiring the hostname and IP address of the virtual machine 3. However, the virtual machines 3 have frequently changed hostname and IP address if the virtual machines 3 have frequent migrations. The manger needs to troublesomely inquire the base-information database 2 to exactly know the location of the specific virtual machine 3.

Moreover, a host (either a physical machine or a virtual machine) usually directly records the hostname and IP address of the virtual machines 3 in the connection configuration file when the host needs to continuously connect to the virtual machines 3 to access the service of the virtual machines 3. The host cannot connect to the virtual machines 3 when the hostname and IP address of the virtual machines 3 are changed due to migration. Therefore the host user generally needs to obtain the new IP address of the virtual machines 3 through inquiring the base-information database 2, and then manually logs in the host and replaces the old IP address in the connection configuration file with new IP address. This is very inconvenient for user and manager of cloud end system.

### SUMMARY OF THE INVENTION

The present invention is to provide a method for managing topology of virtual machine (VM) and management system using for the same. The method for managing topology can automatically trace and update the topology architecture in cloud end virtual environment, whereby an inquirer can know the location of VM by using the alias name of the VM.

Accordingly, the present invention provides a topology management system for virtual machine (VM), comprising a base-information database, a topology information database and an information register processing unit. The base-information database records a plurality of internal information in a VM as the VM is installed. The information register processing unit monitors the base-information database and updates the topology information database with the plurality of internal information of the added or modified VM stored in the base-information database. The topology information database records a mapping between the alias name of VM and the hostname of VM, and a mapping between the hostname of VM and the IP address of VM, wherein the alias name of VM is defined by the task assigned to the VM.

In comparison with related art topology management method and system, the topology management method and system according to the present invention can map the alias name of VM to the correct hostname and IP address. The VM can be inquired and successfully connected by a unique alias name no matter whether the hostname and IP address of VM are changed due to migration. Namely, the inquirer for the VM needs only to remember the alias name of the VM instead of inquiring the detailed migration record or knowing the exact location of the VM.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of a related art management scheme for virtual machines.

FIG. 2 shows the schematic diagram of the first preferred embodiment of the present invention.

FIGS. 3A and 3B show the schematic diagram for the upper-layer table and the lower-layer table, respectively.

FIG. 4 shows the VM migration in the first embodiment

FIGS. 5A and 5B show the upper-layer table 61 and the lower-layer table 62 in the second embodiment, respectively.

FIG. 6 shows a flowchart for establishing table according to the first embodiment of the present invention.

FIG. 7 shows the flowchart for updating topology according to the first embodiment of the present invention.

FIG. 8 shows the flowchart for inquiring location of VM according to an embodiment of the present invention.

FIG. 9 shows the schematic diagram of inquiry operation according to the first embodiment of the present invention.

FIG. 10 shows schematic diagram of the second embodiment of the present invention.

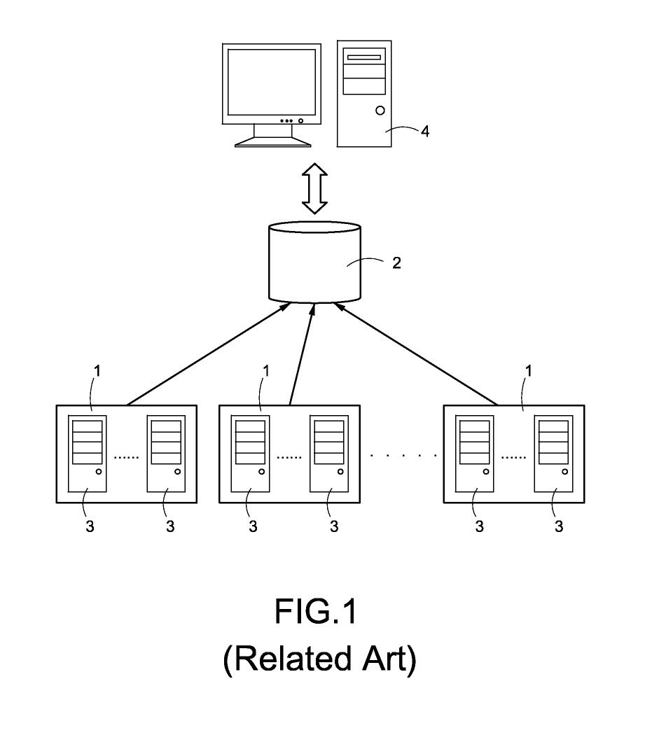

### DETAILED DESCRIPTION OF THE INVENTION

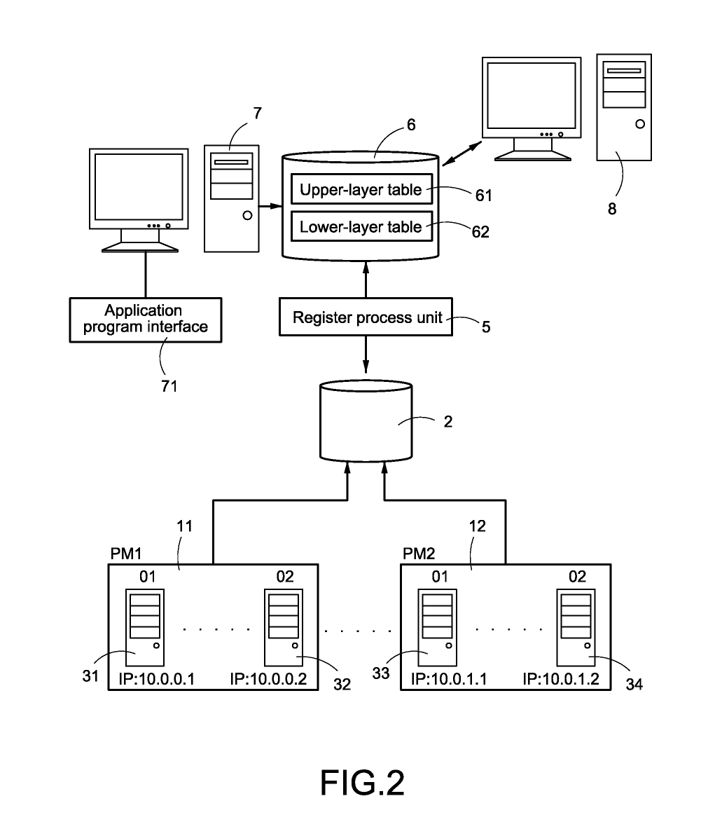

FIG. 2 shows the schematic diagram of the first preferred embodiment of the present invention. The present invention provides a topology management system for virtual machines, the topology management system mainly comprises a plurality of physical machines (PM) 11, 12, a base-information database 2, an information register processing unit 5 and a topology information database 6. The information register processing unit 5 is operated in one of the physical machines 11, 12, which are exemplified with the first host 11 and the second host 12. However, the physical machines can be realized with other number than two.

Each of the physical machines 11, 12 runs one or more virtual machine(s) 31-34. In this embodiment, the first host 11 runs the virtual machine (VM) 31 and VM 32, the second host 12 runs the VM 33 and the VM 34, respectively. The base-information database 2 mainly stores a plurality of internal information of the VM 31-34, where the internal information is for example, but not limited to, hostname, IP address and media access control (MAC) address. It should be noted that, in cloud end system, a PM generally writes the internal information into the base-information database 2 to pre-indicate that a VM compatible with the internal information is to be installed and then the VM is installed according to the internal information.

The information register processing unit 5 is operatively connected to the base-information database 2 and the topology information database 6 and regularly monitors the base-information database 2 to timely know the establishment and migration of VM. The information register processing unit 5 updates the topology information database 6 with the internal information of the VM when the data in the base-information database 2 is changed.

More particularly, the system manager can set up the information register processing unit 5 to access the base-information database 2 with a predetermined frequency (for example, once per 10 minutes or per 30 minutes) or to access the base-information database 2 with a specific event-driven condition (such as VM migration). Moreover, the information register processing unit 5 compares the newly fetched data with the previously fetched data stored in the base-information database 2. The newly fetched data is determined to be the updated VM data when data discrepancy occurs. Therefore, the information register processing unit 5 updates the topology information database 6 with the newly fetched data to automatically trace and manage the VM data.

For example, the information register processing unit 5 knows the hostname and IP address of newly established VM 31 from the base-information database 2. Then, the information register processing unit 5 writes the hostname and IP address of the newly established VM 31 into the topology information database 6 to set up exclusive entry for the VM 31. Moreover, the information register processing unit 5 will regularly monitor the base-information database 2 and can find the change of hostname and IP address in the VM 31 when the VM 31 has migration. The information register processing unit 5 fetches the updated hostname and IP address of the VM 31 from the base-information database 2 and then updates the topology information database 6 with the new hostname and IP address of the VM 31. In this embodiment, the information register processing unit 5 can trace the VM 31 through identification information of the VM 31 in the base-information database 2 to determine whether the hostname and IP address of the VM 31 are changed. The identification information is for example, but not limited to, the MAC address of the VM 31.

As above mention, the hostname and IP address of the VM 31-34 might be changed upon the migration thereof. The manager needs to inquiry the base-information database 2 by himself to know the new location of the VM 31-34 (for example, one of the VM 31-34 is moved from the first host 11 to the second host 12). According to the present invention, the VM has a fixed alias name set by the system manager after the VM is installed and the alias name is stored in the topology information database 6 to generation an association (namely a mapping) among the alias name, the hostname and the IP address of the VM, namely, the alias name is associated with the hostname and the IP address of the VM. The alias name is defined by the character of the VM (the task assigned to the VM). For example, the VM can be assigned with the alias name of www1 if the VM is assigned with cloud end web service. Moreover, the VM can be assigned with the alias name of computer3 if the VM is the third VM assigned with computing service. However the above example is only for demonstration and not limitation of the present invention.

In the present invention, the system can further comprise a setting terminal 7 operatively connected to the topology information database 6 and having an application program interface (API) 71. The API 71 is used to set alias name for the VM in the system. When a new VM is installed, the information register processing unit 5 only writes internal information including the hostname and IP address into the topology information database 6. The system manager can log in the setting terminal 7 and operate the API 71 to define an exclusive and fixed alias name to the new VM. The alias name of the VM is not changed as long as the task assigned to the VM is not changed. The hostname and IP address of the VM might be changed when the VM is migrated. However, the topology management system of the present invention can acquire the topology information database 6 to find the VM by the alias name thereof. In other word, the inquirer can establish connection with the VM by the alias name of the VM, even the inquirer has not the information of migration location.

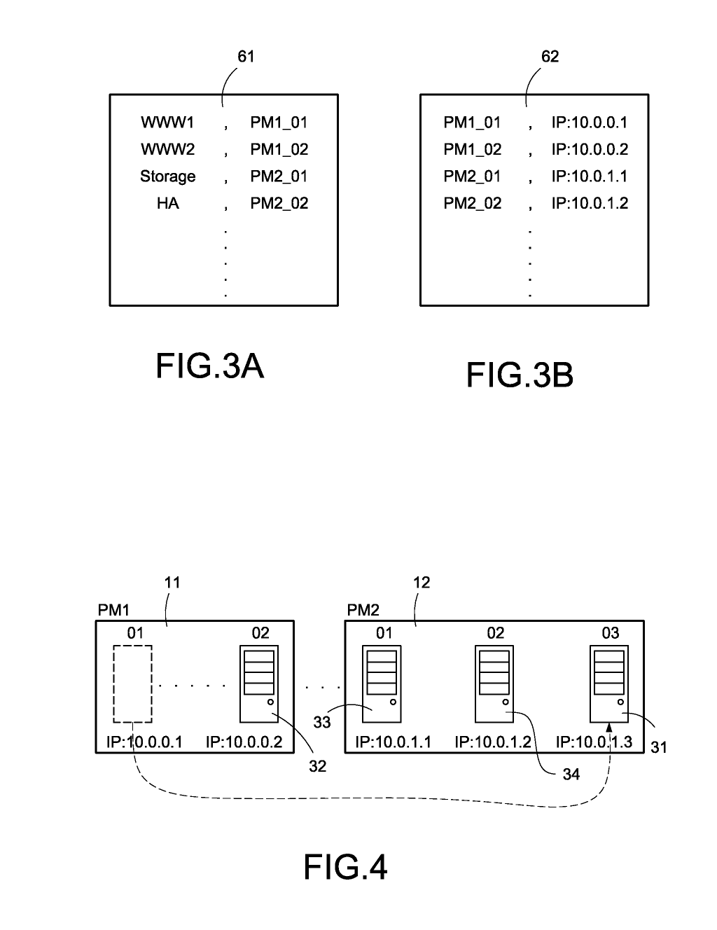

FIGS. 3A and 3B show the schematic diagram for the upper-layer table and the lower-layer table, respectively. With also reference to FIG. 2, the topology information database 6 has an upper-layer table 61 and a lower-layer table 62. As shown in FIGS. 3A and 3B, the upper-layer table 61 records the mapping between alias name and hostname of each VM 31-34, and the lower-layer table 62 records the mapping between hostname and IP address of each VM 31-34. The information register processing unit 5 can dynamically update the upper-layer table 61 and the lower-layer table 62. Therefore, the system manager can know the topology of the virtual environment in the cloud end by inquiring the upper-layer table 61 and the lower-layer table 62 no matter how the VM is installed, moved or deleted.

According to an example, the VM 31 is installed in the first host 11 and is the first VM in the first host 11. The topology management system assigned the VM 31 with hostname “PM1_{—}01” and IP address of “10.0.0.1”, and assigns the task of the VM 31 as web service server. The system manager can record the alias name of the VM 31 as “www1” through the setting terminal 7. In this example, the first data entry in the upper-layer table 61 is “www1, PM1_{—}01” (namely, the mapping between the alias name and the hostname in VM 31), the first data entry in the lower-layer table 62 is“PM1_{—}01, 10.0.0.1” (namely, the mapping between the hostname and IP address in VM 31). Therefore, an inquirer can get the VM with hostname “PM1_{—}01” through the upper-layer table 61 when the user uses the alias name “www1” for inquiry in the topology information database 6, the inquirer can further get the IP address “10.0.0.1” of the VM through the lower-layer table 62 when the user uses the hostname “PM1_{—}01” for inquiry. The inquirer can then establish connection with the VM by the inquired IP address.

In this example, the hostname “PM1_{—}01” is used to indicate that the VM 31 is installed in the first host 11 and is the first VM in the first host 11. Even though it is a common way for naming the hostname, it should be noted that the host name can have coding in other way, not limited by the above mentioned specific coding.

As shown in FIG. 2, the first host 11 also installs a second VM 32, where the second VM is a web server with alias name “www2”, hostname “PM1_{—}02”, and IP address “10.0.0.2”. The second host 12 installs two virtual machines VM 33 and VM 34. The VM 33 is a storage server with alias name “storage1”, host name “PM2_{—}01” (namely, the first VM in the second host 12), and IP address “10.0.1.1”. The VM 34 is a high availability (HA) server with alias name “HA”, hostname “PM2_{—}02” (namely, the second VM in the second host 12), and IP address “10.0.1.2”. For a demonstration of above example, the inquirer can obtain the IP address (namely “10.0.0.2”) of VN 32 by inquiring the topology information database 6 with alias name “www2”. The inquirer can obtain the IP address (namely “10.0.1.1”) of VN 33 by inquiring the topology information database 6 with alias name “storage1”, and can obtain the IP address (namely “10.0.1.2”) of VN 34 by inquiring the topology information database 6 with alias name “HA” and so on.

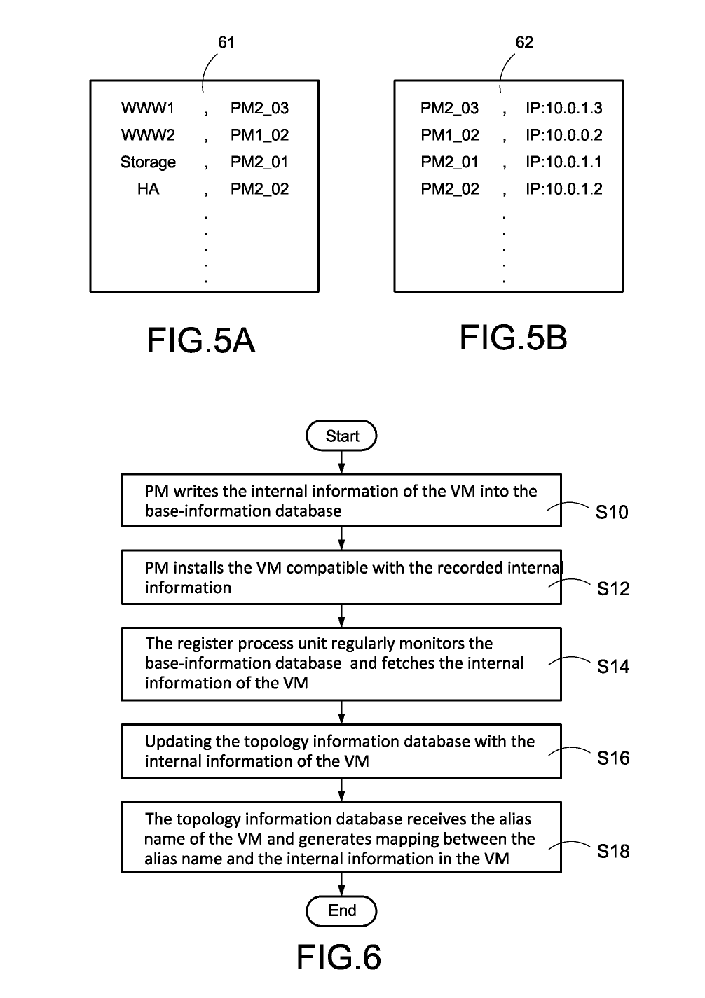

With reference now to FIG. 4 that shows the VM migration in the first embodiment. FIGS. 5A and 5B show the upper-layer table 61 and the lower-layer table 62 in the second embodiment, respectively. As shown in FIG. 4, the hostname and IP address of the VM 31 may be changed when the VM 31 is migrated from the first host 11 to the second host 12. For example, the hostname is changed from “PM1_{—}01” to “PM2_{—}03” (the third VM in the second host 12) and the IP address is correspondingly changed from “10.0.0.1” to “10.0.1.3”.

As above description, the base-information database 2 has record of identification information, such as MAC address of the VM 31-34. The information register processing unit 5 traces the VM 31-34 by the MAC address recorded in the base-information database 2, and the information register processing unit 5 can accordingly determine whether the hostname and IP address of the VM 31-34 are changed. The information register processing unit 5 can update the topology information database 6 (namely update the upper-layer table 61 and the lower-layer table 62) with the changed hostname and IP address of the VM 31-34 when there is any change in the hostname and IP address of the VM 31-34.

As shown in FIGS. 5A and 5B, after the VM 31 is migrated, the information register processing unit 5 will update the upper-layer table 61 and the lower-layer table 62 with the changed hostname and IP address of the VM 31. In those drawings, the hostname of the VM 31 is changed from “PM1_{—}01” to “PM2_{—}03” and the IP address of the VM 31 is changed from “10.0.0.1” to “10.0.1.3” while the alias name of the VM 31 is kept as “www1”. Therefore, the VM 31 can be easily found by inquiring the topology information database 6 with the alias name “www1” even though the inquirer does not know the nee hostname and the new IP address of the VM 31.

FIG. 6 shows a flowchart for establishing table according to the first embodiment of the present invention. The PM writes the internal information of the VM into the base-information database 2 when the VN is to be installed (step S10), and then the PM installs the VM compatible with the recorded internal information (step S12). More particularly, the PM writes the internal information including the hostname and IP address to be assigned to the VM into the base-information database 2 and then installs the VN according to the hostname and IP address recorded in the base-information database 2. Through the above mentioned steps S10 and 12, the base-information database 2 is recorded with the internal information of all VMs in the topology management system.

Afterward, the topology management system regularly monitors the base-information database 2 by using the information register processing unit 5 and fetches the internal information of the VM in the base-information database 2 (step S14). The information register processing unit 5 updates the topology information database 6 with the internal information of the VM (step S16). Finally, the topology information database 6 receives and stores the alias name of the VM defined by the setting terminal 7 and generates a mapping between the alias name and the internal information (namely the hostname and IP address) in those VM (step S18). In other word, the alias name of a VM is mapped to the hostname and the IP address of the same VM. The setting terminal 7 uses the API 71 to define the alias name of those VM, which are corresponding to the assigned tasks.

More particularly, in step S18, the topology information database 6 writes the mapping relationship between the hostname and IP address of VM into the lower-layer table 62, and writes the mapping between the alias name and the hostname of VM into the upper-layer table 61. Therefore, the topology information database 6 can set up the upper-layer table 61 and the lower-layer table 62 shown in FIG. 3A and FIG. 3B.

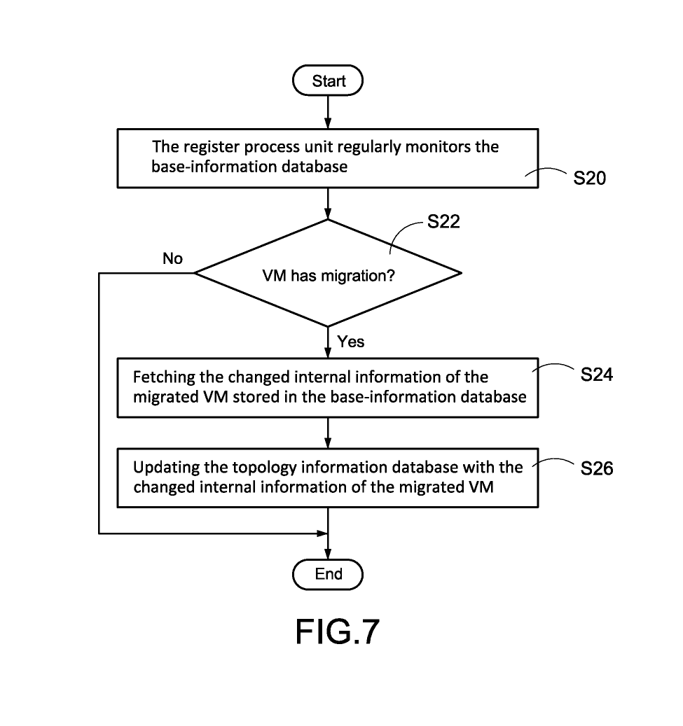

FIG. 7 shows the flowchart for updating topology according to the first embodiment of the present invention. In this embodiment, the information register processing unit 5 regularly monitors the base-information database 2 (step S20) and the information register processing unit 5 determines whether the VM has migration by examining the internal information of VM stored in the base-information database 2 (step S22). As above description, the base-information database 2 stores the identification information of the VM, such as MAC address. Therefore, in step S22 the information register processing unit 5 traces the VM through the MAC address and then determines whether the internal information of VM is changed. The VM is determined by the information register processing unit 5 to have migration if the internal information of VM stored in the base-information database 2 is changed. On the contrary, the VM is determined by the information register processing unit 5 to remain in the original PM if the internal information of VM stored in the base-information database 2 is not changed.

After step S22, the information register processing unit 5 fetches the changed internal information of VM stored in the base-information database 2 if the information register processing unit 5 determines that the VM has migration (step S24). The information register processing unit 5 updates the topology information database 6 with the changed internal information of VM (step S26). More particularly, the upper-layer table 61 and the lower-layer table 62 in the topology information database 6 are updated with the changed hostname and IP address of the VM.

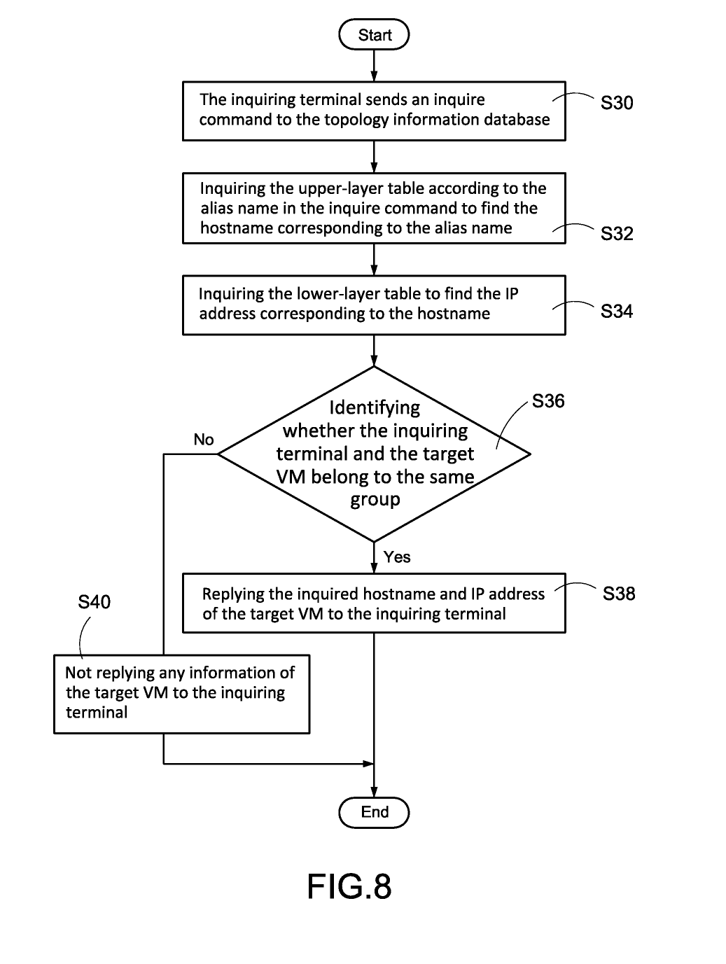

FIG. 8 shows the flowchart for inquiring location of VM according to an embodiment of the present invention. An inquirer can use an inquiring terminal (such as the inquiring terminal 8 shown in FIG. 8) to send an inquiring command to the topology information database 6 as the inquirer intends to find a target VM (step S30), where the inquiring command comprises at least the alias name of the target VM. The topology information database 6 checks the upper-layer table 61 according to the alias name in the inquiring command to find the hostname corresponding to the alias name (step S32). The topology information database 6 then checks the lower-layer table 62 to find the IP address corresponding to the hostname (step S34). Finally, the topology information database 6 sends the inquired hostname and IP address to the inquiring terminal 8. In the embodiment, the inquiring terminal 8 can be either PM or VM, and the inquiring terminal 8 is operated by a manager to passively issue the inquiring command. Alternatively, the inquiring terminal 8 can be a host in operation and actively issues the inquiring command if necessary.

It should be noted the topology management system is a cloud end system and can provide service for different groups (such as different companies) at the same time. Therefore, security issue is a big concern if user can arbitrarily inquire the information of all VM in the system without any filtering mechanism. According to the embodiment, the topology information database 6 further receives a source information (not shown) from the inquiring terminal 8 besides receiving the inquiring command. The topology information database 6 can identify whether the inquiring terminal 8 and the target VM belong to the same group by comparing the source information and the internal information of the target VM (step S36). The topology information database 6 will reply the inquired hostname and IP address of the target VM to the inquiring terminal 8 if the inquiring terminal 8 and the target VM belong to the same group (step S38). On the contrary, the topology information database 6 will not reply any information of the target VM to the inquiring terminal 8 if the inquiring terminal 8 and the target VM do not belong to the same group (step S40).

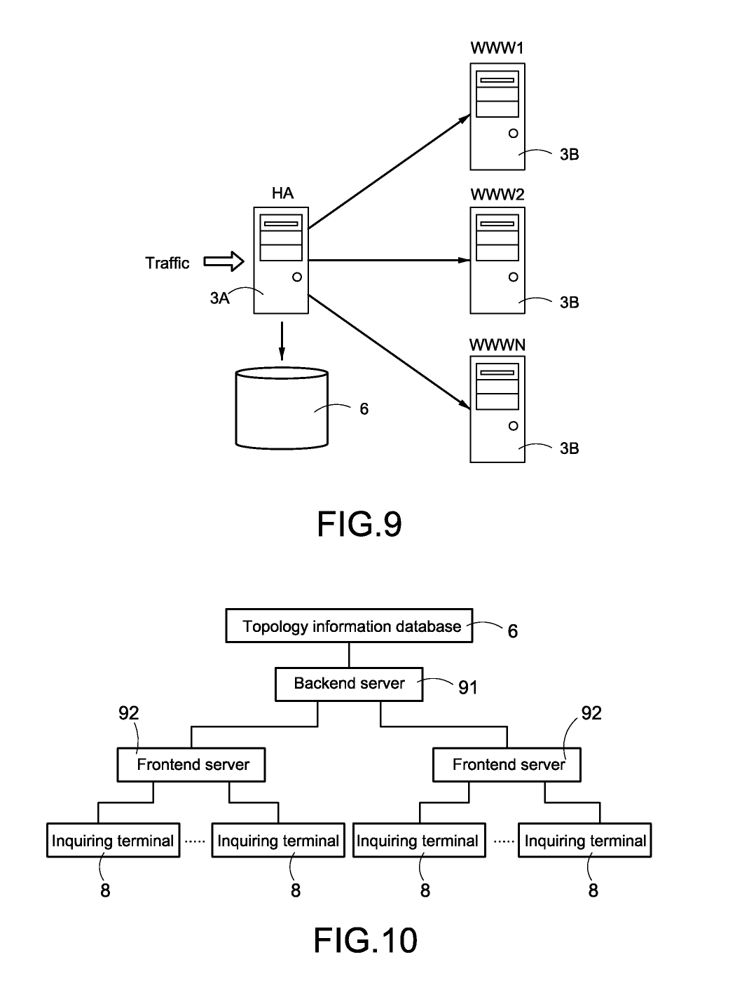

FIG. 9 shows the schematic diagram of inquiry operation according to the first embodiment of the present invention. As shown in the figure, the topology management system comprises a HA host 3A, which can be either a PM or a VM. The present invention further provides the inquiry operation shown in FIG. 9 when a traffic flows into the HA host 3A and the HA host 3A intends to performs re-direct for the traffic. For example, the HA host 3A inquires the topology information database 6 with the alias name “www” if the HA host 3A intends to re-direct the traffic to a plurality of web servers, and the topology information database 6 finds a plurality of web servers 3B matched with the alias name “www” (as shown in FIG. 9, there are a plurality of web servers 3B with alias name “www1,” “www2” and “www3”) and the hostnames and IP addresses of those web servers 3B. Therefore, the HA host 3A can easily re-direct traffic to the plurality of web servers 3B. High availability (HA) host is well known art and the detailed operation of the HA host 3A is not described here for brevity.

The prior art HA host generally needs to record the IP addresses of the plurality of web servers 3B therein for re-directing the traffic to those plurality of web servers 3B. Accordingly, if the IP addresses of the web servers 3B are changed due to migration thereof, the system manager needs to find the new IP addresses of web servers 3B and manually replace the old IP addresses with the new IP addresses after logging in the HA host. It is really troublesome. According to the present invention, the HA host 3A only needs to record the generic alias name “www” and uses the generic alias name to inquire the topology information database 6 for finding the web servers 3B. In this way, the HA host 3A can easily know the IP addresses of the web servers 3B and then connects with the web servers 3B.

FIG. 10 shows schematic diagram of the second embodiment of the present invention. In the embodiment shown in FIG. 2, the inquiring terminal 8 directly connects with the topology information database 6 to inquire and receive the internal information from the target VM. As shown in FIG. 10, the topology management system is implemented in 3-tier architecture to enhance system stability. The topology management system in this embodiment comprises a backend server 91 and at least one frontend server 92. The backend server 91 operatively connects with the topology information database 6 to inquire the topology information database 6. The at least one frontend server 92 operatively connects with the backend server 91 and at least one inquiring terminal 8. The at least one frontend server 92 receives and processes inquiring command sent from the inquiring terminal 8 and then sends the processed inquiring command to the backend server 91 for inquiry. The frontend server 92 sends the inquiry result of the backend server 91 back to the inquiring terminal 8.

More particularly, the inquiring command sent from the inquiring terminal 8 and received by the frontend server 92 contains at least alias name for the target VM. The frontend server 92 sends the processed inquiring command to the backend server 91 for inquiry, and the backend server 91 inquires the topology information database 6 with the alias name in the inquiring command to find the hostname and IP address of the target VM. The backend server 91 then sends the hostname and IP address of the target VM to the frontend server 92, whereby the frontend server 92 can reply the hostname and IP address of the target VM to the inquiring terminal 8.

In this embodiment, the inquiring command issued by the inquiring terminal 8 is mainly a DNS inquiring command, more particularly, the inquiring command is, but not limited to, a standard C library call such as gethostbyname( ) command. The frontend server 92 performs a DNS reverse resolution to obtain the alias name of the target VM after receiving the inquiring command from the inquiring terminal 8. The frontend server 92 generates a DNS reply for answering to the inquiring terminal 8 after the frontend server 92 receives the hostname and IP address of the target VM.

Generally, the gethostbyname( ) command sends a name (such as an alias name) to a DNS server and the DNS server obtains a corresponding domain name (such as www.delta.com.tw) by DNS reverse resolution. In the present embodiment, the frontend server 92 is simulated to act as a DNS server. For example, after the frontend server 92 receives the inquiring command, the backend server 91 inquires the topology information database 6 according to the alias name in the inquiring command and obtains the hostname and IP address for the target VM. The backend server 91 then sends the hostname and IP address for the target VM to the frontend server 92. The frontend server 92 generates a DNS reply complied with DNS protocol based on the hostname and IP address of the target VM. Namely, the DNS reply contains the information of hostname and IP address for the target VM and is complied with DNS protocol. For example, the DNS reply can be, but not limited to, hostname.IP address.delta.com.tw. The inquiring terminal 8 obtains the hostname and IP address for the target VM from the DNS reply.

The topology management system of the present invention can also perform above-mentioned filtering mechanism by the frontend server 92. The frontend server 9 receives the inquiring command from the inquiring terminal 8 and at the same time receives the source information from the inquiring terminal 8. After receiving the hostname and IP address of the target VM from the backend server 91, the frontend server 9 determines whether the inquiring terminal 8 and the target VM belong to the same group (for example, the same company) by comparing the source information with the hostname/IP address of the target VM. The frontend server 92 sends the hostname and IP address of the target VM to the inquiring terminal 8 through DNS reply if the inquiring terminal 8 and the target VM belong to the same group. The frontend server 92 will not send any information of the target VM to the inquiring terminal 8 through DNS reply if the inquiring terminal 8 and the target VMs do not belong to the same group to ensure security for client's data.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A topology management system for virtual machine (VM), comprising:
a base-information database configured to record a plurality of internal information in a VM, the plurality of internal information including hostname and IP address of the VM;
a topology information database; and
an information register processing unit operatively connecting to the base-information database and the topology information database, the information register processing unit configured to monitor the base-information database and to update the topology information database with the plurality of internal information of the VM stored in the base-information database,
wherein the VM has a fixed alias name defined with reference to a task assigned to the VM, the alias name being stored in the topology information database and having a mapping with a hostname and an IP address of the VM in the topology information database.

2. The topology management system in claim 1, wherein the topology information database comprises an upper-layer table storing a mapping between the alias name of the VM and the hostname of the VM and a lower-layer table storing a mapping between the hostname of the VM and the IP address of the VM

3. The topology management system in claim 2, wherein the base-information database is further configured to record an identification information of the VM.

4. The topology management system in claim 3, wherein the information register processing unit is configured to trace the VM according to the identification information when the VM has migration and to determine whether the internal information in the VM is changed, the information register processing unit is configured to update the upper-layer table and the lower-layer table in the topology information database when the internal information in the VM is changed.

5. The topology management system in claim 1, further comprising a setting terminal operatively connected to the topology information database and having an application program interface (API), the API defining the alias name of the VM after receiving external operation and writing the alias name into the topology information database to establish mapping for the alias name and the hostname and the IP address of the VM.

6. The topology management system in claim 1, further comprising at least one physical machine (PM) operatively connected to the base-information database, the VM writing the plurality of internal information into the base-information database and installing the VM according to the plurality of internal information.

7. The topology management system in claim 1, further comprising:
a backend server operatively connected to the topology information database; and
a frontend server operatively connected to the backend server and an inquiring terminal,
wherein the frontend server receives an inquiring command from the inquiring terminal and sending the inquiring command to the backend server, the inquiring command comprising the alias name of the VM, the backend server inquiring the topology information database with the alias name to obtain the hostname and the IP address for the VM, the frontend server sending the hostname and the IP address for the VM to the inquiring terminal.

8. The topology management system in claim 7, wherein the inquiring command is gethostbyname( ) command.

9. The topology management system in claim 8, wherein the frontend server process the inquiring command according to a DNS reverse resolution process and generates a DNS reply to the inquiring terminal, wherein the DNS reply comprises the hostname and the IP address of the VM.

10. The topology management system in claim 7, wherein the frontend server further receives a source information of the inquiring terminal and determines whether the inquiring terminal and the VM belong to a same group, the frontend server sends the hostname and the IP address of the VM to the inquiring terminal when the inquiring terminal and the VM belong to the same group.

11. A topology management method for virtual machine (VM), the method used for a topology management system, the topology management system comprising a base-information database, a topology information database and an information register processing unit, the base-information database recording a plurality of internal information in a VM, the method comprising:
a) the information register processing unit monitoring the base-information database;
b) the information register processing unit updating the topology information database with the plurality of internal information of the VM stored in the base-information database;
c) the topology information database receiving an alias name of the VM defined by a setting terminal, the alias name being defined according to an assigned task of the VM;
d) the topology information database recording the alias name and generating a mapping between the alias name and the plurality of internal information of the VM in the topology information database.

12. The topology management method in claim 11, wherein the plurality of internal information comprise hostname and IP address of the VM, the topology information database comprising an upper-layer table and a lower-layer table, wherein the mapping between the alias name of the VM and the hostname of the VM is written in the lower-layer table in step d and the mapping between the hostname of the VM and the IP address of the VM is written in the upper-layer table in step d.

13. The topology management method in claim 12, wherein the topology management system further comprises a physical machine (PM) and the method further comprising following steps before the step a:
a01) the PM writing the hostname and the IP address of the VM into the base-information database; and
a02) the PM installing the VM according to the hostname and the IP address.

14. The topology management method in claim 12, further comprising:
e) after step a, the information register processing unit judging whether the hostname and the IP address of the VM are changed to determine whether the VM has migration;
f) the information register processing unit fetching the changed hostname and the IP address of the VM if the VM has migration; and
g) writing the changed hostname and the IP address of the VM into the topology information database to update the upper-layer table and the lower-layer table.

15. The topology management method in claim 14, wherein the base-information database has an identification information of the VM, wherein in step e the information register processing unit traces the VM according to the identification information to determine whether the hostname and the IP address of the VM are changed.

16. The topology management method in claim 14, further comprising:
h) receiving an inquiring command from an inquiring terminal, the inquiring command comprising the alias name of the VM;
i) inquiring the upper-layer table according to the alias name to obtain the hostname of the VM;
j) inquiring the lower-layer table according to the hostname to obtain the IP address of the VM; and
k) replying the hostname and the IP address of the VM to the inquiring terminal.

17. The topology management method in claim 16, further comprising following steps before the step k;
k01) obtaining a source information of the inquiring terminal;
k02) determining whether the inquiring terminal and the VM belong to a same group by the source information;
k03) executing the step k if the inquiring terminal and the VM belong to the same group; and
k04) not replying to the inquiring terminal if the inquiring terminal and the VM do not belong to the same group.

18. A topology management system for virtual machine (VM), comprising:
a physical machine (PM) installing a VM thereon;
a base-information database operatively connected to the PM and configured to record a hostname and an IP address of the VM;
a topology information database comprising an upper-layer table and a lower-layer table;
an information register processing unit operatively connecting to the base-information database and the topology information database, the information register processing unit configured to monitor the base-information database and to update the topology information database with the plurality of internal information of the VM stored in the base-information database,
a setting terminal operatively connected to the topology information database and having an application program interface (API), the API defining the alias name of the VM after receiving external operation and writing the alias name into the topology information database;
wherein the upper-layer table records a mapping between the alias name of the VM and the hostname of the VM, the lower-layer table records a mapping between the hostname of the VM and the IP address of the VM.

19. The topology management system in claim 18, wherein the base-information database has an identification information of the VM, wherein the information register processing unit is configured to trace the VM according to the identification information when the VM has migration and to determine whether the hostname and the IP address of the VM are changed, the information register processing unit is configured to fetch the changed hostname and the IP address of the VM and update the upper-layer table and the lower-layer table in the topology information database when the hostname and the IP address of the VM are changed.

20. The topology management system in claim 19, further comprising:
a backend server operatively connected to the topology information database; and
a frontend server operatively connected to the backend server and an inquiring terminal,
wherein the frontend server receives an inquiring command from the inquiring terminal and processes the inquiring command according to a DNS reverse resolution process, the frontend server obtains the alias name of the VM in the inquiring command and sends the alias name to the backend server, the backend server inquires the topology information database with the alias name to obtain the hostname and the IP address for the VM, the frontend server generates a DNS reply to the inquiring terminal based on the hostname and the IP address of the VM.
